(19) United States
(12) Patent Application Publication
(10) Pub. No.: US 2010/0319498 A1
(43) Pub. Date: Dec. 23, 2010

(54) Power assisted lever arm ratchet

(76) Inventors: Paul V. Mannino, Scotch Plains, NJ (US); Gary Boccadutre, Pittstown, NJ (US)

Correspondence Address: HORST M. KASPER, 13 FOREST DRIVE, WARREN, NJ, 07059, US

(21) Appl. No.: 12/806,934

(22) Filed: Aug. 24, 2010

Related U.S. Application Data
(63) Continuation of application No. 09/841,570, filed on Apr. 24, 2001, now Pat. No. 7,779,731.

(51) Int. Cl. B25B 21/00; B25B 13/46; B25B 23/16

(52) U.S. Cl. 81/57.39; 81/60; 81/177.2

(57) ABSTRACT

An improved power assisted lever arm ratchet which has a 6″ to 30″ extension and drive shaft between the ratchet handle and the ratchet head.

### BACKGROUND OF THE INVENTION

1. Field of the Invention

The present invention relates to power assisted hand tools and more particularly power assisted ratchets.

2. Description of the Prior Art

Power assisted ratchets, in numerous configurations are well known in the art. Typical air, hydraulic or electric driven ratchets fall into several well-defined classifications, including gun type impact wrenches typified by a Chicago Pneumatic CP-7XX (series impact wrenches and lever arm ratchets with the gun type impact wrenches typically used for larger size sockets and lever arm type ratchets typically for smaller size ¼″. ⅜″ and ½″ drive sockets or their metric is equivalents. These lever arm ratchets also position the socket drive at the end of the ratchet in the ratchet head generally perpendicular to the long axis of the ratchet. There are also some configurations, used typically for ¼″ drive sockets, in which the socket drive is mounted at the end of the device approximately in line with the long axis of the ratchet.

In the present state of the art, power assisted lever arm ratchets have the ratchet head closely coupled to a handle which typically encloses a pneumatic motor. This closely coupled configuration is used by all of the manufacturers of power assisted lever arm type ratchets including Milwaukee Pneumatic, Chicago Pneumatic, Ingersoll-Rand, Daytona, American Rodcraft, Northern Tools and Equipment Company and many others. While all of these tools are useful embodiments of power assisted lever arm ratchets, their configuration fails to address long-standing needs including accessibility in tight environments, obstruction of the users vision when working in confined areas, wrist and hand stress and hand injuries resulting from jerking or slipping ratchets. Some manufacturers have begun to address some of these problems: for example a “cushion grip” feature is used by Northern Industrial Tools on air ratchet model numbers 158308-B952 and 158309-B952, Snap-On uses a “Santroprene” “ergonomic handle”, NAPA ratchet model NPT 6-731 features a “comfortable ergonomic motor housing” and Dayton offers a model 5Z273 “ergonomic reactionless ratchet” which it suggests “eliminates torque reaction, which means no more bloody or bruised knuckles when working in tight areas”. However, the current state of the art as embodied in the numerous examples cited above do not address the accessibility or view obstruction problems except by trying to make the ratchets more compact, which exacerbates the potential for injury by requiring the user's hand to be closer to the machinery. In addition, aside from the “ergonomic” grips or attempts to reduce the occurrence of torque reaction jerking or slipping of a ratchet, noting in the prior art addresses the problems of hand/arm injuries or stress and strain induced repetitive motion injuries.

### SUMMARY OF THE INVENTION

It is a general objective of the present invention to provide for an improved power assisted lever arm ratchet which addresses these long-standing needs and provides for an improved design.

It is an object of the present invention to provide the user with an improved power assisted lever arm ratchet that reduces the force and grip strength needed to hold the ratchet during use.

It is a further object of the present invention to provide an improved power assisted lever arm ratchet that is able to reach otherwise inaccessible locations in engine compartments in automotive repair and assembly operations as well as similar situations involving other types of equipment.

It is also an object of the present invention to provide for an improved power assisted lever arm ratchet allows the user to grip the ratchet in a position removed from the immediate vicinity of the work area such that the users hand is not subject to injury if the ratchet jerks or slips causing the user's hand to impact on the equipment.

It is an additional object of the present invention to provide for an improved power assisted lever arm ratchet which permits the user to position the user's hand away from the work area to reduce obstruction of the user's view of the area of the equipment being worked on.

It is also an object of the present invention to provide for a device that can be added to existing power assisted lever arm ratchets to provide the improvements embodied in this invention.

Is an additional objective of the present invention to provide for variable length extenders to power assisted lever arm ratchets to accomplish the improvements embodied in this invention.

It is also an object of the present invention to provide a power assisted lever arm ratchet which has fixed or removable user selected extensions to accomplish the improvements embodied in the present invention.

### BRIEF DESCRIPTION OF THE DRAWINGS

The following drawings illustrate the preferred embodiment of the within invention as well as alternative embodiments.

FIG. 1 is a prospective view of a power assisted lever arm ratchet embodying the features of the present invention.

FIG. 2 is a cross-section view of the preferred embodiment of the present invention.

FIG. 3 illustrates the components needed to convert a conventional power assisted lever arm ratchet into one incorporating the features of the present invention.

FIGS. 4A and 4B illustrate embodiments of the present invention with a replaceable extension to provide for different length ratchet extensions.

### DETAILED DESCRIPTION OF THE DRAWINGS

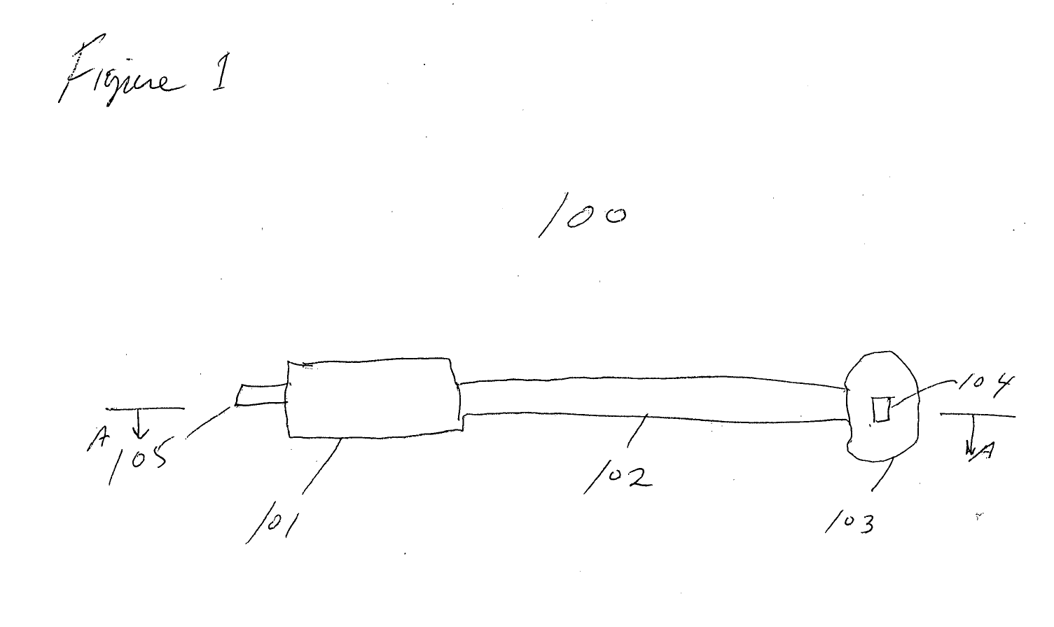

Referring to FIG. 1 which illustrates improved power assisted lever arm ratchet 100 which is further comprise of ratchet handle 101, which handle typically encloses a powered drive motor, ratchet extension 102, ratchet head 103, which head typically encloses a right angle drive mechanism, socket mount 104 and air line connection 105. In the preferred embodiment, ratchet extension 102 is approximately 11 inches in length. However extensions from approximately six inches to as much as thirty inches are considered to be useful and are contemplated by the present invention.

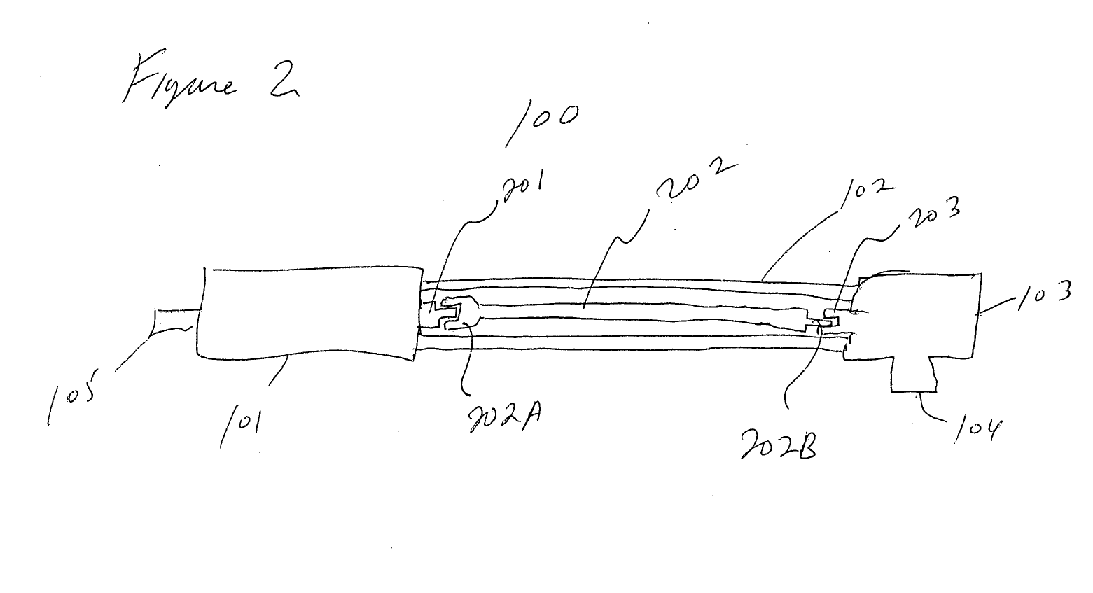

FIG. 2 illustrates improved power assisted lever arm ratchet 100 viewed through section line A-A in FIG. 1 and illustrates extension shaft 202 which is located inside of ratchet extension 102. Drive shaft 201 engages drive socket 202 A on drive extension shaft 202. Drive extension shaft 202 then engages ratchet head drive shaft 203 via drive tang 202 B. The advantage of drive extension shaft 202 having drive socket 202 A and drive tang 202 B facilitates the manufacturing of improved lever arm ratchet 100 with various extension lengths while permitting ratchet handle 101 and ratchet head 103 to be manufacturing in a standard configuration. Embodiments in which drive shaft 201 extends through ratchet extension 102 to engage directly with head drive in shaft 203 is also a contemplated by the present invention as is a configuration in which a drive shaft from ratchet handle 101 is connected directly to ratchet head 103 as well as extending head drive shaft 203 to engage drive shaft 201 at ratchet handle 101. In all of the foregoing embodiments ratchet handle 101 is fixedly or removably attached to ratchet head 103 by means of ratchet extension 102 such that the position of ratchet handle 101 relative to ratchet head 103 is maintained when ratchet 100 is activated for normal use such as attaching or removing fasteners.

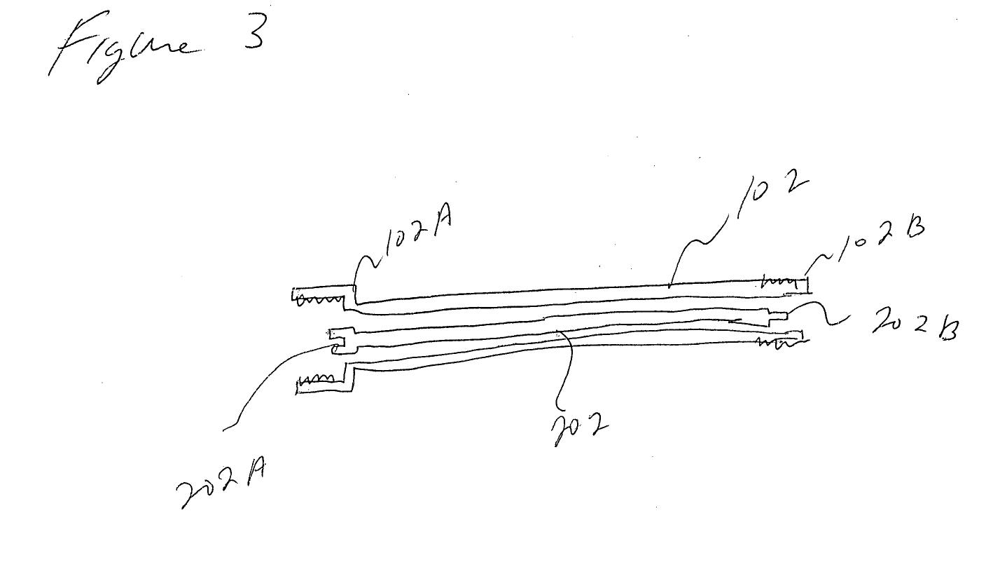

FIG. 3 illustrates an embodiment of drive extension 102 which is designed for use with existing air ratchets to incorporate the drive extension features of the present invention. In this embodiment drive extension 102 incorporates interface collar 102 A and ratchet head mount 102 B in addition to drive extension shaft 202. Some embodiments of existing power assisted lever arm ratchets are designed to facilitate repair or replacement of components by permitting ratchet head 103 to be detached from ratchet handle 101. There are various methods of attaching these compounds together and for illustration purposes a threaded connection involving male threads located on the end of ratchet handle 101 engaging a threaded collar on ratchet head 103 is shown. In this embodiment of the present invention interface collar 102 A is threaded onto the male threads located on the end of ratchet handle 101. Interface thread 102B is threaded into the threaded collar on ratchet head 103. Drive extension shaft 202 via drive socket 202A engages drive shaft 201 in the same manner as head drive shaft 203 the other end of drive extension shaft 202 via drive tang 202 B engages head drive shaft 203. FIG. 3 illustrates a slot/tang drive shaft engagement configuration which is one of several used in existing air ratchets. However the present invention contemplates any configuration in which ratchet head 103 is removeably attached to ratchet handle 101 as well as any detachable or fixed drive shaft configuration.

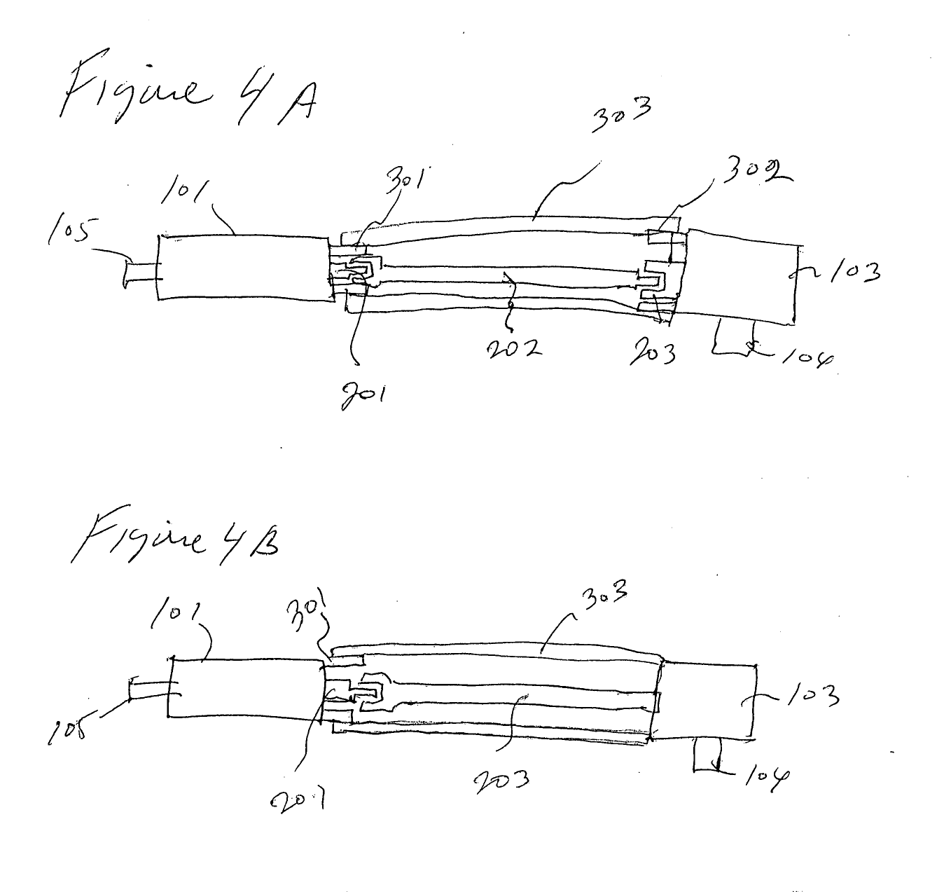

FIGS. 4 A and 4B illustrate additional embodiments of the present invention providing for replaceable extensions of different lengths. In FIG. 4A ratchet handle 101 incorporates drive extension sleeve mounting collar 301 and drive extension mounting collar 302 which is incorporated into ratchet head 103. Drive extension shaft 202 of an appropriate length is engaged with either drive shaft 201 or ratchet head drive shaft 203 and extension sleeve 303 in an appropriate length is slipped over drive extension shaft 202, the unengaged end of drive extension shaft 202 is engaged with either drive shaft 201 or ratchet head drive shaft 203 and extension sleeve 303 is removably attached to drive extension sleeve mounting collar 301 and drive extension collar 302 completing the assembly of this embodiment of the present invention. In FIG. 4B extension sleeve 303 is fixedly attached to ratchet head 103 and ratchet head drive shaft 203 is extended to a length appropriate, when used with extension sleeve 303, to engage drive shaft 201 when extension sleeve 303 is removably attached to drive extension sleeve mounting collar 301. It is clear that other alternative embodiments are possible and contemplated by the present invention including the attachment of extension sleeve 303 to ratchet handle 101 and extending drive shaft 201 or various combinations of extension sleeves and drive shafts coupled at any point to permit easy assembly and disassembly to change the length of the extension.

The present invention as described in the foregoing can be seen as providing an improved power assisted lever arm ratchet design which provides for easy access to inaccessible or awkwardly accessible portions of mechanical devices for assembly and/or repair. The present invention also provided for reduced stress on the user when the ratchet is activated and applies torque to attach or remove fasteners due to the extension and increased lever arm length provided by this improved ratchet. The length of the extension can be selected based on the additional reach desired by the user as well as the amount of torque reduction desired.

The particular embodiments of the preferred invention and alternatives which have been shown and described above are intended to be illustrative of the features of the present invention, however it is obvious onto those skilled in the art that changes and modifications can be readily made without departing from the scope of the present invention. It is therefore intended that all such changes and modifications fall within the scope of the present invention.

We claim:

1. An improved power assisted lever arm ratchet which is comprised of a ratchet handle containing a drive motor, a ratchet extension, a ratchet extension shaft and a ratchet head.

2. An improved power assisted lever arm ratchet as described in claim 1 in which said ratchet extension and ratchet extension shaft are approximately six to thirty inches in length.

3. An improved power assisted lever arm ratchet which is comprised of a ratchet handle containing a drive motor, a removable ratchet extension, a removable ratchet extension shaft and a ratchet head.

4. An improved power assisted lever arm ratchet as described in claim 3 in which said ratchet extension and ratchet extension shaft are approximately six to thirty inches in length.

5. An improved power assisted lever arm ratchet which is comprised of a ratchet handle containing a drive motor, a plurality of different length removable ratchet extensions, a plurality of removable ratchet extension shafts and a ratchet head.

6. An improved power assisted lever arm ratchet as described in claim 5 in which said ratchet extensions and ratchet extension shafts range from approximately six to thirty inches in length.

7. An improved power assisted lever arm ratchet which is comprised of a ratchet handle containing a drive motor fixedly attached to a ratchet extension, a ratchet extension shaft fixedly attached to said ratchet handle and a removable ratchet head.

8. An improved power assisted lever arm ratchet as described in claim 7 in which said ratchet extension and ratchet extension shaft are approximately six to thirty inches in length.

9. An improved power assisted lever arm ratchet which is comprised of a ratchet head fixedly attached to a ratchet extension, a ratchet extension shaft fixedly attached to said ratchet head and a removable ratchet handle containing a drive motor.

10. An improved power assisted lever arm ratchet as described in claim 9 in which said ratchet extension and ratchet extension shaft are approximately six to thirty inches in length.

11. A ratchet extension and extension shaft with attachment means to permit said extension and extension shaft to be installed on a conventional power assisted lever arm ratchet.
